(19) United States
(12) Patent Application Publication
(10) Pub. No.: US 2023/0215244 A1
(43) Pub. Date: Jul. 6, 2023

(54) FINANCIAL INSTRUMENT PERFORMANCE-BASED PARI-MUTUEL BETTING SYSTEM AND METHOD

(71) Applicant: EBET, INC., Las Vegas, NV (US)

(72) Inventor: Aaron Speach, San Diego, CA (US)

(21) Appl. No.: 18/093,290

(22) Filed: Jan. 4, 2023

Related U.S. Application Data
(60) Provisional application No. 63/296,428, filed on Jan. 4, 2022.

(51) Int. Cl. G07F 17/32

(52) U.S. Cl. CPC G07F 17/3288; G07F 17/323; G07F 17/3276; G07F 17/3213

(57) ABSTRACT

A system and method for conducting pari-mutuel betting on the performance of financial instruments as a betting pool type. The system and method execute an electronic or online betting experience where the “participants” in a race are a number of similar financial instruments such as individual stocks, cryptocurrency or regular currency pairs, commodities, or indices, etc. The system and method can be employed using any group of financial instruments, or items, that have a price or index or some other metric that fluctuates over time.

### CROSS-REFERENCES TO RELATED APPLICATIONS

The present application claims priority of U.S. Provisional Application No. 63/296,428, filed Jan. 4, 2022, and entitled “FINANCIAL INSTRUMENT PERFORMANCE-BASED PARI-MUTUEL BETTING SYSTEM AND METHOD”, the entirety of which is incorporated by reference herein.

### TECHNICAL FIELD

The subject matter described herein relates to a pari-mutuel betting system and method, and more particularly to a system and method for conducting pari-mutuel betting on the performance of cryptocurrencies as a betting pool type.

### BACKGROUND

Pari-mutuel betting is a system of betting in which all bets of a particular type are placed together in a pool, vigorish (or “vig”), i.e., the house take, is deducted, and payoff odds are calculated by sharing the pool among all winning bets. Common and well-known forms of pari-mutuel betting are applied to an event centered around a pool of a similar type or class of participant, such as horse racing, greyhound racing, jai alai, and other sporting events of relatively short duration, and in which participants of the pool finish in a ranked order. A modified pari-mutuel system is also used in some lottery games.

In pari-mutuel betting, the final payout is not determined until the pool is closed, where the final odds are based on what bettors actually bet before the event. The bettors' actual bets can be based on initial odds generated for the pool of participants based on a number of factors. For example, in horse racing, the initial odds (before bettors place their bets) can be determined on each horse's condition, form, class, history, and other factors. Unlike many other forms of gambling, in pari-mutuel betting the gambler bets against other gamblers, not the house, which necessarily implies that the bank cannot be broken. The science of predicting the outcome of a race is called handicapping.

In conventional pari-mutuel frameworks, the pool is presented with many different kinds of potential outcomes on which bettors can place bets, and against which complex commissions and/or payouts can be calculated. In some examples, such as horse racing, the pool size often extends into millions of dollars, with many different types of outcomes (winning horses, order of placing, etc.) and complex commission calculations, and there may be several different types of bets, where each type of bet has its own pool.

In various financial market exchanges, such as the New York Stock Exchange (NYSE), or the National Association of Securities Dealers Automated Quotations (NASDAQ), which is a collection of a number of national stock and options exchanges, investors can buy and sell shares of stocks listed on their exchanges. In many respects, investors are “betting” on which direction an individual stock will take and can aggregate such bets in various trading blocks. However, each individual stock representing a share price of each individual company is very different from all other stocks, despite being loosely associated within a particular industry or competitive realm, in that every company is vastly different in terms of personnel, resources, operations and the like. As such, it is very difficult to pool individual stocks within a common pool type, other than based on an industry or technology sector.

Another form of betting that is gaining popularity is betting on electronic sports (“esports”). Esports can range from digital sports games to competitive multi-player games online that are conducted over a network.

### SUMMARY

In one aspect, a system for conducting pari-mutuel betting on the performance of financial instruments as a betting pool type is disclosed. In another aspect, a method for conducting pari-mutuel betting on the performance of financial instruments as a betting pool type is disclosed. The system and method create an electronic or online betting experience like a horse race, but where the participants in the race are a number of similar financial instruments such as individual stocks, cryptocurrency or regular currency pairs, commodities, or indices, etc. The system and method can be employed using any group of financial instruments, or items, that have a price or index or some other metric that fluctuates over time.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a system and method for conducting pari-mutuel betting on the performance of cryptocurrencies as a betting pool type, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a process flow diagram illustrating aspects of a method having one or more features consistent with implementations of the current subject matter;

FIG. 2 shows a graphical representation of a race using financial instruments as race participants in a betting pool; and

FIG. 3 shows a diagram illustrating aspects of a system showing features consistent with implementations of the current subject matter.

When practical, similar reference numbers denote similar structures, features, or elements.

### DETAILED DESCRIPTION

A system and method for conducting pari-mutuel betting on the performance of financial instruments as a betting pool type are described. The system and method execute an electronic or online betting experience, similar to a real-life horse race, but where the “participants” in the race are a number of similar financial instruments such as individual stocks, cryptocurrency or regular currency pairs, commodities, or indices, etc. The system and method can be employed using any group of financial instruments, or items, that have a price or index or some other metric that fluctuates over time.

A “race” is defined by a fixed period of time, during a real-time trading period where the financial instrument is being publicly traded. Races take place over a fixed period, for example 5 minutes, which period can be set at any duration and configured to be started and stopped at any time. In some examples, the fixed period can be a few seconds or less to many hours or more. Further, such period can be repeated, for example every 5 minutes or once an hour.

In some implementations, the system determines the “winner” of each race by the largest change since the start of the period. For financial instruments such as a cryptocurrency, as an example, this could be a percentage change from the start of the race period to the end of the race period. In some implementations, for example, the “race” can be which instrument decreases the least, although betting on a greater decline can still be implemented.

As the race clock runs, each financial instrument price may move up or down for a positive or negative change. In order to create a familiar race-like experience these positive and negative changes can be transformed to positive numbers only, representing a “distance” traveled by a participant in the pool over the race. In some implementations, this distance can be displayed on screen of a graphical user interface (GUI) on a client device, and graphically represented as a physical race between other non-related items (e.g. horses, cars, greyhounds, etc) but for which pari-mutuel betting has conventionally occurred.

Bettors can place bets on who will win (e.g., have the largest % change) during the race period up to a fixed time before the end of the period (e.g. for a 5 minute period bets may be allowed until 15 seconds before the end). Bets will be placed into a pari-mutuel pool and new odds calculated based on the size of each bet. At the end of the race period the pari-mutuel pool will be paid out based on the finishing position of each item.

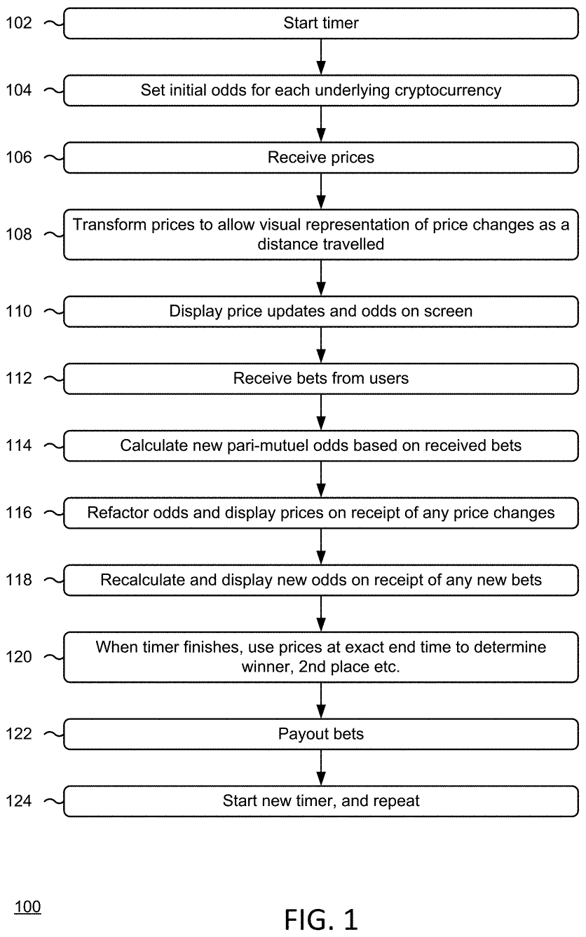

FIG. 1 is a flowchart depicting a method 100 of conducting pari-mutuel betting on the performance of financial instruments, consistent with implementations described herein, and using cryptocurrencies as the betting pool type. At 102, a timer is started. The timer can be depicted as a graphical representation in a GUI, and also represents the time period of the “race” that is the subject of the pari-mutuel betting. The timer can be set at a fixed period, i.e. 5 minutes, and/or can be repeatedly started over the course of a longer period of time, i.e. a trading day of a financial trading exchange. At 104, the system sets initial odds for each individual cryptocurrency that is part of the pool (e.g., ETH, BTC, DOGE, SHIB, LTC, etc.). These initial odds can be set using one or more odds-setting algorithms, which can take into account a trading history, a future outlook, expert analysis or other factors of each individual cryptocurrency.

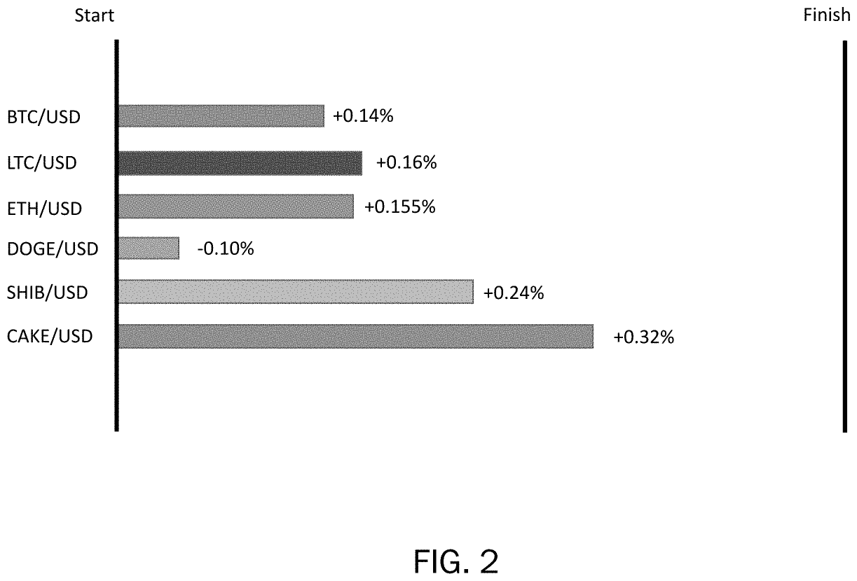

At 106, upon starting of the timer, the system receives prices for each of the cryptocurrencies, which can be their then currently trading price per unit. At 108, the system can transform the prices, and their movement up or down, to a graphical representation of some other item, such as a horse or a car, for example, to allow a visual representation of price changes as a distance traveled by the other item, such as in a real-life race between horses or cars or other things, as but some examples. See FIG. 2, for example. At 110, the system displays price updates and updating odds on a screen generated for the GUI on the client computer, and at 112 receives bets from users based on those odds. The bets can be received and used to update the odds.

At 114, the system calculates new pari-mutuel odds based on received bets, and at 116 re-factors odds and displays prices on receipt of any price changes. At 118, the system recalculates and displays new odds on receipt of any new bets. When the timer finishes, i.e., the “race” period ends, at 120 the system uses prices at the exact end time to determine a winner, a 2nd place finisher, etc., and any combination of pari-mutuel betting outcomes. At 122, the system pays out based on the bets from users via their respective client computers, and at 124, a new timer is started and the process repeats.

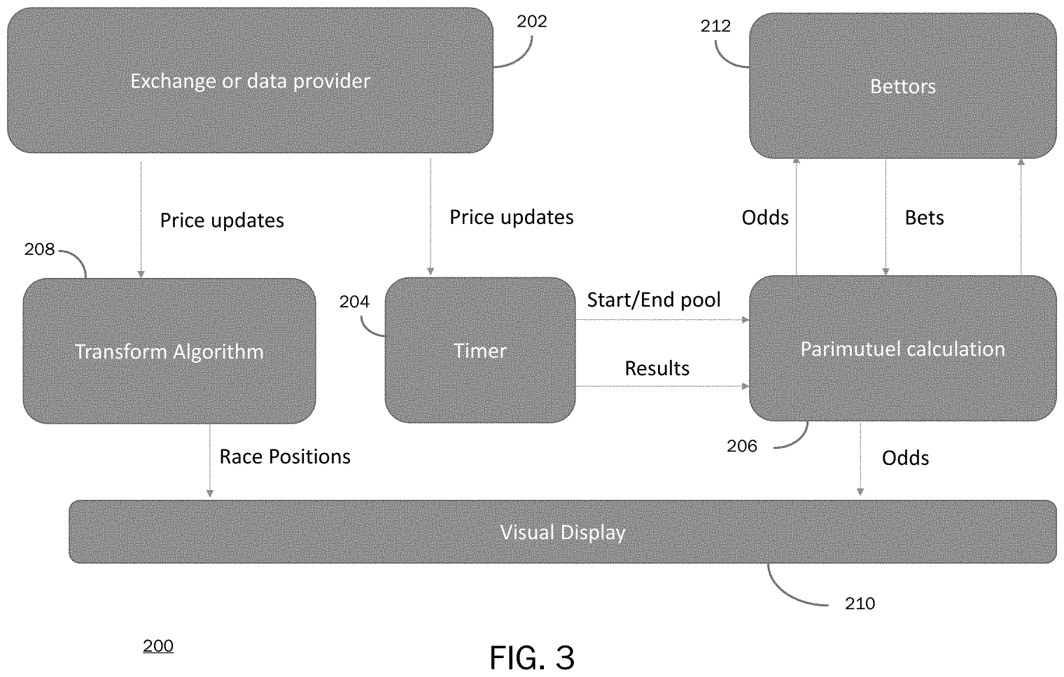

FIG. 3 is a functional block diagram of a system 200 for conducting pari-mutuel betting on the performance of financial instruments, consistent with implementations described herein. The financial instruments, such as individual stocks, cryptocurrency or regular currency pairs, commodities, or indices, etc. are bought and sold and traded on an exchange 202, which acts as a data provider to the system 200. A timer 204 represents a “race” and can be set with a start time and an end or finish time. The timer 204 can also be set with a start time, and the finish represents when one of the financial instruments in the betting pool is first to achieve a trading milestone, such as percentage gain or loss, for instance, and all other “participants in the betting pool are assessed for their place based on the finish, either a point in time or when the first financial instrument reaches the predetermined milestone.

A pari-mutuel calculator 206 receives the start and finish data from the timer 204, and generates and sets initial odds for each underlying financial instrument in the betting pool, which can also be considered a heat or a race. The timer 204 receives initial prices for the financial instruments at start time of the race and receives price updates throughout the race and sends those updates as results to the pari-mutuel calculator 206, which displays the odds and results to a visual display 210, which can be a GUI on a client computer, for example. A transformer 208 also receives price updates and transforms those prices to a graphical representation of a different item, such as shown in FIG. 2, or which can also be a physical object like a horse or a car, and can represent these updates as race positions throughout the race. These race positions can also be represented and displayed in the visual display 210.

As discussed above, at least some of the visual display 210 can be represented in a GUI of a client computing device used by one or more bettors 212, who receive initial odds from the pari-mutuel calculator 206 and who place bets to the pari-mutuel calculator 206, preferably via an associated client computing device. The one or more bettors 212 continuously receive updated odds based on their bets as well as price updates from the exchange 202 via the timer 204.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A pari-mutuel betting method comprising:
selecting a financial instrument from a group of financial instruments, the group of financial instruments comprising individual stocks, cryptocurrency or regular currency pairs, commodities, or indices;
setting, by a computing system, odds for the selected financial instrument for a predetermined time period;
receiving, by the computing system, prices for the selected financial instrument based on the odds;
transforming, by the computing system, price changes of the selected financial instrument over a period of time to a visual representation of a distance traveled on a predetermined course, the distance traveled having a time component to represent a race of the selected financial instrument against other financial instruments in the group of financial instruments;
displaying, by the computing system, price updates based on the price changes and the associated visual representation of the distance traveled; and
receiving, by the computing system, bets from one or more users on the selected financial instrument against the other financial instruments.

2. The pari-mutuel betting method in accordance with claim 1, further comprising calculating, by the computing system, new pari-mutuel odds of the distance traveled by selected financial instrument against the other financial instruments based on the received bets.

3. The pari-mutuel betting method in accordance with claim 2, further comprising re-factoring the new pari-mutuel odds to generate new prices for the bets from the one or more users.

4. The pari-mutuel betting method in accordance with claim 3, further comprising determining, by the computing system, a winner of the bets based on the distance traveled by the selected financial instrument against the other financial instruments for the predetermined time period.
